(19) United States
(12) Patent Application Publication
(10) Pub. No.: US 2020/0167118 A1
(43) Pub. Date: May 28, 2020

(54) PROJECTOR SYSTEM AND PROJECTOR SETTING METHOD

(71) Applicant: Coretronic Corporation, Hsin-Chu (TW)

(72) Inventor: Hsin-Ya Lai, Hsin-Chu (TW)

(73) Assignee: Coretronic Corporation, Hsin-Chu (TW)

(21) Appl. No.: 16/694,892

(22) Filed: Nov. 25, 2019

(30) Foreign Application Priority Data
Nov. 26, 2018 (CN) 201811414723.0

(51) Int. Cl. G06F 3/14; H04N 9/31; G06F 3/0482; G06F 3/0484; H04L 12/28; H04L 29/12

(52) U.S. Cl. CPC G06F 3/1423; H04N 9/3147; H04L 61/2007; G06F 3/04847; H04L 12/28; G06F 3/0482

(57) ABSTRACT

The disclosure proposes a projector system and a projector setting method. The projector system includes a first projector and a plurality of second projectors, wherein the first projector is connected to the second projectors via a network. The first projector receives a group creation command. The first projector transmits the group creation command to at least one of the second projectors via the network to create a projector group according to the at least one of the second projectors. When the first projector receives a setting command, the first projector transmits the setting command to at least one of the second projectors in the projector group via the network. The at least one of the second projectors in the projector group changes a set value according to the setting command. The disclosure is capable of setting one or a plurality of projectors fast and conveniently.

### CROSS-REFERENCE TO RELATED APPLICATION

This application claims the priority benefit of China application serial no. 201811414723.0, filed on Nov. 26, 2018. The entirety of the above-mentioned patent application is hereby incorporated by reference herein and made a part of this specification.

### BACKGROUND

### Technical Field

The disclosure relates to a projector system and a projector setting method, and particularly relates to a projector system and a projector setting method for setting one or a plurality of projectors.

### Related Art

When there is a plurality of projectors in the same place, the projectors may be set one by one using a remote control. This method is, however, cumbersome and time consuming. In addition, a projector group may be set through central control software. However, in this method, a computer or other electronic device is required as a central console for installing the central control software, and a user is also required to be able to operate the central control software. Currently, some methods for setting a plurality of projectors are cumbersome, while other methods require additional hardware. Therefore, how to set one or a plurality of projectors is a goal that those skilled in the art should strive for.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

The disclosure provides a projector system and a projector setting method that set one or a plurality of projectors.

The disclosure proposes a projector system, including a first projector and a plurality of second projectors, wherein the first projector is connected to the second projectors via a network. The first projector receives a group creation command. The first projector transmits the group creation command to at least one of the second projectors via the network to create a projector group according to the at least one of the second projectors. When the first projector receives a setting command, the first projector transmits the setting command to at least one of the second projectors in the projector group via the network. The at least one of the second projectors in the projector group changes a set value according to the setting command.

The disclosure proposes a projector setting method suitable for a projector system including a first projector and a plurality of second projectors, the first projector being connected to the second projectors via a network. The projector setting method includes the following. A group creation command is received by the first projector. By the first projector, the group creation command is transmitted to at least one of the second projectors via the network to create a projector group according to the at least one of the second projectors. When the first projector receives a setting command, the setting command is transmitted by the first projector to at least one of the second projectors in the projector group via the network. A set value is changed by the at least one of the second projectors in the projector group according to the setting command.

Based on the above, in the projector system and the projector setting method of the disclosure, the first projector receives the group creation command and transmits the group creation command to the other projectors via the network to create the projector group. When the first projector receives the setting command, the first projector transmits the setting command to the other projectors in the projector group via the network. When the other projectors in the projector group receive the setting command, the other projectors change the set value according to the setting command.

Other objectives, features and advantages of the invention will be further understood from the further technological features disclosed by the embodiments of the invention wherein there are shown and described preferred embodiments of this invention, simply by way of illustration of modes best suited to carry out the invention.

To make the aforementioned and other features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a projector system according to an embodiment of the disclosure.

FIG. 2 is a schematic diagram of the projector system according to an embodiment of the disclosure.

FIG. 3 is a schematic diagram of manually inputting an Internet protocol (IP) address to create a group according to an embodiment of the disclosure.

FIG. 4 is a schematic diagram of automatically detecting an IP address to create a group according to an embodiment of the disclosure.

FIG. 5 is a schematic diagram of quickly creating a group or canceling a group according to an embodiment of the disclosure.

FIG. 6 and FIG. 7 are schematic diagrams of message transmission between a main projector and secondary projectors according to an embodiment of the disclosure.

FIG. 8 is a flowchart of a projector setting method according to an embodiment of the disclosure.

FIG. 9 is a flowchart of a projector setting method according to another embodiment of the disclosure.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

FIG. 1 is a block diagram of a projector system according to an embodiment of the disclosure.

Referring to FIG. 1, a projector system 100 according to an embodiment of the disclosure includes a first projector 110 and a plurality of second projectors 120. Each of the first projector 110 and the second projector 120 includes an input unit 101, a processor 102, a networking chip 103, and functional units of a general projector that are coupled to the processor 102, such as an excitation light source driving unit 104, a projection lens adjusting unit 105, a fan driving unit 106 and so on. The input unit 101 may include an infrared sensor and a keyboard, and the input unit 101 may receive an input signal from a user 150. The input signal is, for example, an infrared signal generated by the user 150 pressing a remote control or a signal generated by the user 150 pressing a keypad on a projector housing. The processor 102 is, for example, a microprocessor control unit (MCU) or other similar element. The networking chip 103 supports wired or wireless network connectivity and includes a storage space. This storage space is provided by, for example, an embedded multimedia card (eMMC), a flash memory, or other similar element.

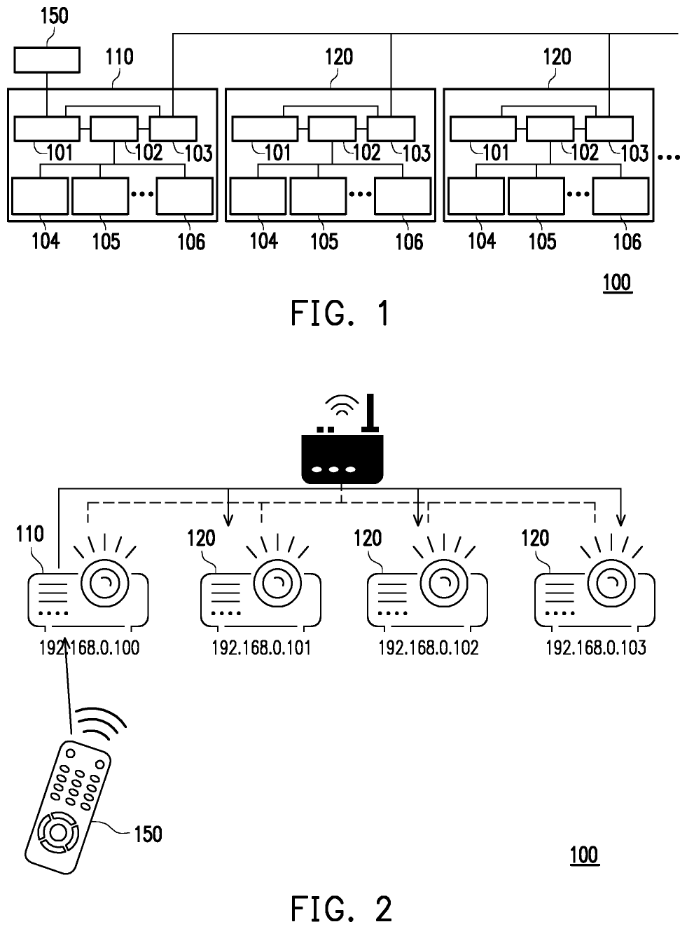

FIG. 2 is a schematic diagram of the projector system according to an embodiment of the disclosure.

Referring to FIG. 2, the projector system 100 according to an embodiment of the disclosure includes the first projector 110 and the second projectors 120. The first projector 110 and the second projectors 120 may connect to each other via a wired or wireless network (as shown in dashed lines in the drawing), and the first projector 110 may transmit a command to the second projectors 120 (as shown in solid lines in the drawing). The first projector 110 receives a group creation command through an input from the user 150. Although FIG. 2 illustrates that the user 150 transmits a message to the first projector 110 by the remote control, the disclosure is not limited thereto. In another embodiment, the user 150 may transmit the message to the first projector 110 through a keypad on the first projector 110. Whether inputting the message through the remote control or the keypad, the user 150 may operate the first projector 110 according to an input interface of an on-screen display (OSD) projected by the first projector 110 on a screen.

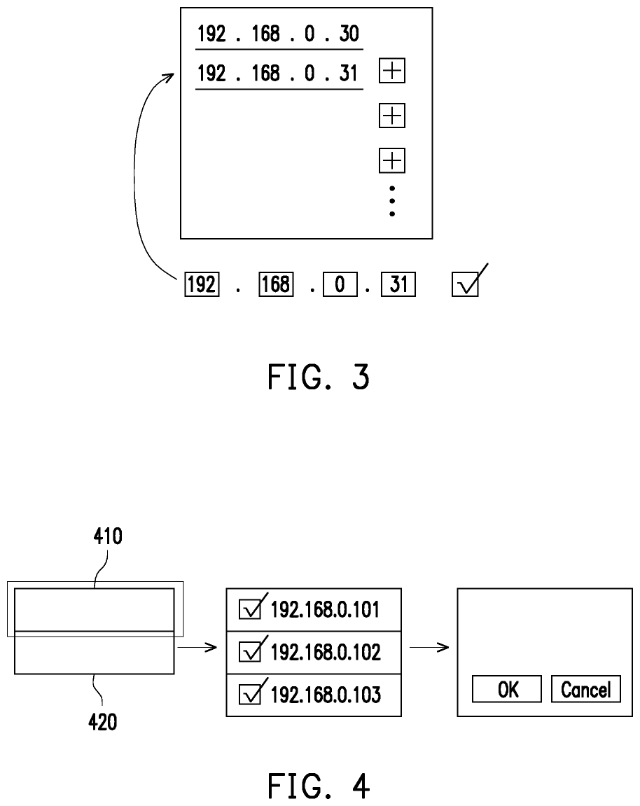

In an embodiment, the group creation command may include a plurality of Internet protocol (IP) addresses and a group creation request, and the first projector 110 may transmit the group creation request to the second projectors 120 corresponding to the IP addresses. For example, the group creation command may include one or a plurality of IP addresses manually input by the user 150, as shown in FIG. 3. The user 150 may add the second projectors 120 with the manually input IP addresses to a group. It is worth noting that the IP addresses manually input by the user 150 are not limited to those in the same domain of the first projector 110.

In an embodiment, the first projector 110 may broadcast the group creation command in the same domain, and may, after receiving a plurality of response messages from the second projectors 120 in the same domain, create a projector group according to the second projectors 120. For example, in FIG. 4, when the user 150 selects an option 410 representing creating a group through the OSD, the processor 102 of the first projector 110 may broadcast the group creation command in the same domain through a device search protocol (e.g., Apple's Bonjour protocol) to detect the second projector 120 of the same model or of a different model within the same domain. Each second projector 120 may store a resident service program (e.g., a daemon) in the storage space of the networking chip 103 therein to wait for connection with other projectors. When the first projector 110 receives the response messages from the second projectors 120 with the IP addresses of 192.168.0.101, 192.168.0.102 and 192.168.0.103, the user 150 may select at least one of the second projectors 120 to add to the group. In another respect, after creating the group, the user 150 may select an option 420 representing canceling a group to cancel the group.

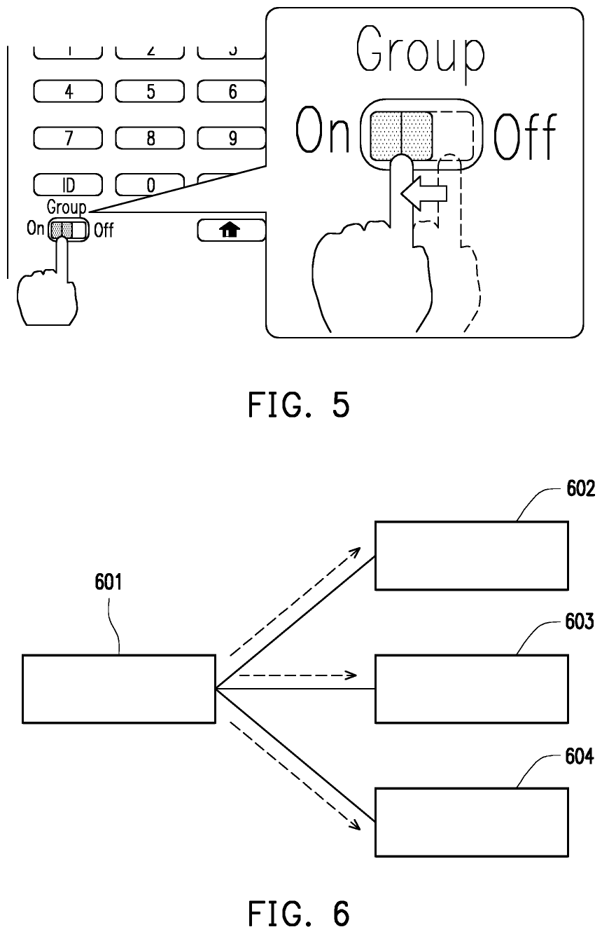

In an embodiment, the user 150 may further quickly create or cancel a group using the remote control. For example, in FIG. 5, the user 150 may quickly create a group through an “On” button on the remote control with respect to the group, or may quickly cancel the group through an “Off” button on the remote control with respect to the group. It is worth noting that, when the user 150 selects “On”, the first projector 110 may add all of the second projectors 120 detected in the same domain to the group.

After the projector group is created, when the first projector 110 receives a setting command, the first projector 110 may transmit the setting command to the second projectors 120 in the projector group simultaneously via the wired or wireless network. The second projectors 120 in the projector group may change a set value according to the setting command. The set value is, for example, a set value of a projector function, such as a color set value, a brightness set value, a language set value, a signal source set value, a resolution set value, an aspect ratio set value or the like. In addition, the first projector 110 may display a menu screen on the screen so as to allow the user 150 to input the group creation command and the setting command through the menu screen.

In another respect, after the projector group is created, when any of the second projectors 120 receives the setting command, the second projector 120 that receives the setting command may transmit the setting command to the other projectors in the projector group via the wired or wireless network.

It is worth noting that, the second projector 120 may also receive the setting command from the first projector 110 when in an off state. The second projector 120 may change the set value according to the setting command and store the changed set value in the storage space of the networking chip 103 therein. When the second projector 120 is turned on (i.e., a light source is turned on), the second projector 120 applies the updated set value to project an image. As clear from the above description, the second projector 120 is capable of turning on a network connection function and receiving the group creation command and the setting command even in the off state.

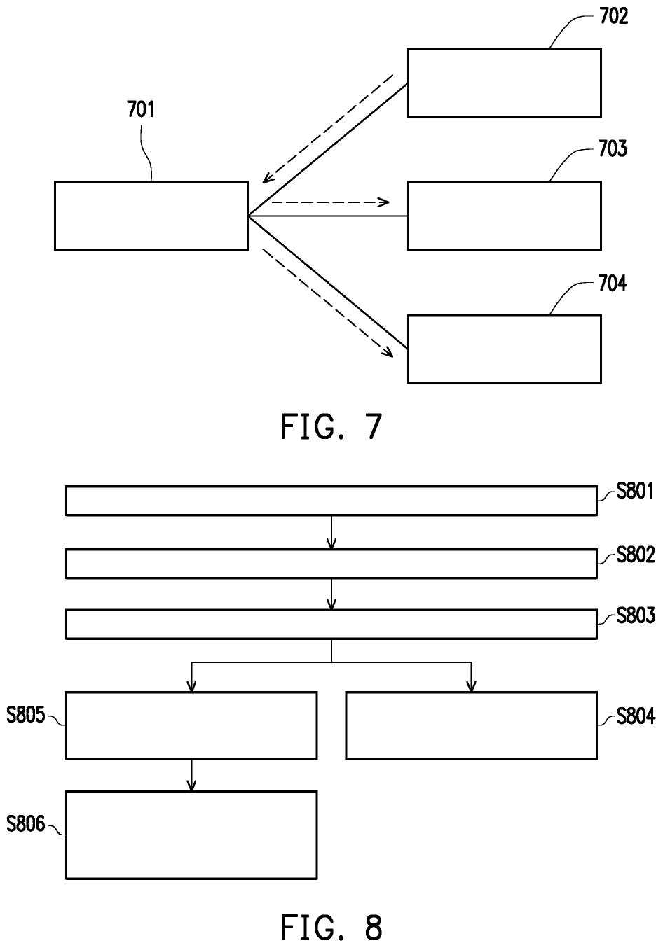

FIG. 6 and FIG. 7 are schematic diagrams of message transmission between a main projector and secondary projectors according to an embodiment of the disclosure.

Referring to FIG. 6, one of the first projector 110 and the second projectors 120 may be a main projector 601 and the other projectors may be secondary projectors 602 to 604. When the first projector 110 is the main projector 601 and the second projectors 120 are the secondary projectors 602 to 604, the first projector 110 receives the group creation command and transmits the group creation command to the secondary projectors 602 to 604. After the projector group is created, the first projector 110 receives the setting command and transmits the setting command to the secondary projectors 602 to 604 simultaneously. The number of the secondary projectors 602 to 604 is not limited to three.

Referring to FIG. 7, one of the first projector 110 and the second projectors 120 may be a main projector 701 and the other projectors may be secondary projectors 702 to 704. When the first projector 110 is the secondary projector 702, and the main projector 701 is one of the second projectors 120, the first projector 110 (i.e., the secondary projector 702) may receive the group creation command and transmit the group creation command to the main projector 701. The main projector 701 may receive the group creation command from the first projector 110 (i.e., the secondary projector 702) and transmit the group creation command to the other secondary projectors 703 to 704. After the projector group is created, the first projector 110 (i.e., the secondary projector 702) may receive the setting command and transmit the setting command to the main projector 701. The main projector 701 may receive the setting command from the first projector 110 (i.e., the secondary projector 702) and transmit the setting command to the other secondary projectors 703 to 704 simultaneously. The number of the secondary projectors 702 to 704 is not limited to three.

FIG. 8 is a flowchart of a projector setting method according to an embodiment of the disclosure.

Referring to FIG. 8, in step S801, the user 150 turns on the first projector 110 and connects the first projector 110 and the second projectors 120 to a network.

In step S802, the IP addresses of the second projectors 120 to be added to the projector group are selected by checking checkboxes (e.g., see FIG. 4) or are manually input (e.g., see FIG. 3) through the OSD of the first projector 110.

In step S803, the creation of the projector group is completed.

In step S804, the user 150 inputs the setting command on the keypad of any projector in the projector group, and all the projectors in the projector group change the set value according to the setting command.

In step S805, the user 150 presses the “On” button on the remote control with respect to the group.

In step S806, the user 150 inputs the setting command to any projector in the projector group using the remote control, and all the projectors in the projector group change the set value according to the setting command.

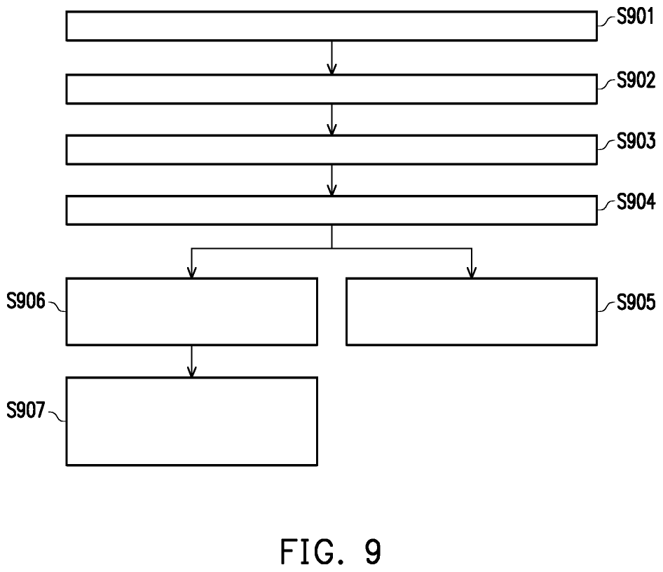

FIG. 9 is a flowchart of a projector setting method according to another embodiment of the disclosure.

Referring to FIG. 9, in step S901, the user 150 turns on the first projector 110 and connects the first projector 110 and the second projectors 120 to a network.

In step S902, the user 150 presses the “On” button on the remote control with respect to the group for the first projector 110.

In step S903, the networking chip 103 of the first projector 110 identifies all the projectors in the same domain.

In step S904, the processor 102 of the first projector 110 adds the identified second projector 120 to the group.

In step S905, the user 150 inputs the setting command on the keypad of any projector in the projector group, and all the projectors in the projector group change the set value according to the setting command.

In step S906, the user 150 presses the “On” button on the remote control with respect to the group.

In step S907, the user 150 inputs the setting command to any projector in the projector group using the remote control, and all the projectors in the projector group change the set value according to the setting command.

In summary, in the projector system and the projector setting method of the disclosure, the first projector receives the group creation command and transmits the group creation command to the other projectors via the network to create the projector group. When the first projector receives the setting command, the first projector transmits the setting command to the other projectors in the projector group simultaneously via the network. When the other projectors in the projector group receive the setting command, the other projectors change the set value according to the setting command.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A projector system, comprising: a first projector and a plurality of second projectors;
the first projector being connected to the second projectors via a network, wherein
the first projector receives a group creation command,
the first projector transmits the group creation command to at least one of the second projectors via the network to create a projector group according to the at least one of the second projectors,
when the first projector receives a setting command, the first projector transmits the setting command to at least one of the second projectors in the projector group via the network, and
the at least one of the second projectors in the projector group changes a set value according to the setting command.

2. The projector system according to claim 1, wherein the group creation command comprises a plurality of Internet protocol addresses, and the first projector transmits the group creation command to at least one of the second projectors corresponding to the Internet protocol addresses.

3. The projector system according to claim 1, wherein the first projector broadcasts the group creation command in a local area network, and after receiving a plurality of response messages from the second projectors in the local area network, creates the projector group according to the second projectors.

4. The projector system according to claim 3, wherein the first projector receives at least one selection signal after receiving the response messages from the second projectors, and selects at least one of the second projectors and creates the projector group according to the selected at least one of the second projectors.

5. The projector system according to claim 1, further comprising a main projector and a plurality of secondary projectors, wherein, when the first projector is the main projector and the second projectors are the secondary projectors, the first projector receives the group creation command and transmits the group creation command to the secondary projectors.

6. The projector system according to claim 5, wherein, when the first projector is one of the secondary projectors and one of the second projectors is the main projector, the first projector receives the group creation command and transmits the group creation command to the main projector, and the main projector receives the group creation command and transmits the group creation command to the secondary projectors.

7. The projector system according to claim 1, wherein the second projectors are in an off state and the second projectors each comprise a networking chip, the first projector receives the setting command and transmits the setting command to the second projectors, and each of the second projectors stores the changed set value in a storage space of the networking chip.

8. The projector system according to claim 1, wherein the first projector receives the group creation command through an infrared sensor.

9. The projector system according to claim 1, wherein the first projector receives the group creation command through an input interface provided on the first projector.

10. The projector system according to claim 1, wherein the first projector is adapted to display a menu screen on a screen so as to allow a user to input the group creation command and the setting command through the menu screen.

11. A projector setting method, applied to a projector system comprising a first projector and a plurality of second projectors, the first projector being connected to the second projectors via a network, wherein the projector setting method comprises:
receiving a group creation command by the first projector;
transmitting the group creation command to at least one of the second projectors via the network by the first projector to create a projector group according to the at least one of the second projectors;
when the first projector receives a setting command, transmitting the setting command to at least one of the second projectors in the projector group via the network by the first projector; and
changing a set value according to the setting command by the at least one of the second projectors in the projector group.

12. The projector setting method according to claim 11, wherein the group creation command comprises a plurality of Internet protocol addresses, and the first projector transmits the group creation command to at least one of the second projectors corresponding to the Internet protocol addresses.

13. The projector setting method according to claim 11, wherein the first projector broadcasts the group creation command in a local area network, and after receiving a plurality of response messages from the second projectors in the local area network, creates the projector group according to the second projectors.

14. The projector setting method according to claim 13, wherein the first projector receives at least one selection signal after receiving the response messages from the second projectors, and selects at least one of the second projectors and creates the projector group according to the selected at least one of the second projectors.

15. The projector setting method according to claim 11, wherein the projector system comprises a main projector and a plurality of secondary projectors, wherein, when the first projector is the main projector and the second projectors are the secondary projectors, the first projector receives the group creation command and transmits the group creation command to the secondary projectors.

16. The projector setting method according to claim 15, wherein, when the first projector is one of the secondary projectors and one of the second projectors is the main projector, the first projector receives the group creation command and transmits the group creation command to the main projector, and the main projector receives the group creation command and transmits the group creation command to the secondary projectors.

17. The projector setting method according to claim 11, wherein the second projectors are in an off state and the second projectors each comprise a networking chip, the first projector receives the setting command and transmits the setting command to the second projectors, and each of the second projectors stores the changed set value in a storage space of the networking chip.

18. The projector setting method according to claim 11, wherein the first projector receives the group creation command through an infrared sensor.

19. The projector setting method according to claim 11, wherein the first projector receives the group creation command through an input interface provided on the first projector.

20. The projector setting method according to claim 11, wherein the first projector is adapted to display a menu screen on a screen so as to allow a user to input the group creation command and the setting command through the menu screen.
